(19) United States
(12) Patent Application Publication
(10) Pub. No.: US 2009/0295881 A1
(43) Pub. Date: Dec. 3, 2009

(54) PRINTER, INK CIRCULATION METHOD AND INITIAL INK INSTALLATION METHOD

(75) Inventors: Kazutaka TASAKA, Kyoto (JP); Jindra VOSAHLO, Theneuille (FR)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO.,LTD.

(21) Appl. No.: 12/468,322

(22) Filed: May 19, 2009

(30) Foreign Application Priority Data
May 27, 2008 (JP) P2008-137482

(51) Int. Cl. B41J 2/175

(52) U.S. Cl. 347/85

(57) ABSTRACT

A printer comprises a head having a plurality of outlets, a first ink tank connected to the head and a second ink tank storing ink, and the second ink tank is connected to the first ink tank via a supply line and connected to the head via a return line. The supply line is provided with a pump for supplying the first ink tank with ink stored in the second ink tank. A main decompressor connected to the second ink tank decompresses the inside of the second ink tank to a negative pressure and ink is returned from the first ink tank to the second ink tank through a passage leading from the first ink tank to the second ink tank via the head. This allows an appropriate circulation of ink while degassing the ink in the second ink tank.

### BACKGROUND OF THE INVENTION

1. Field of the Invention

The present invention relates to an inkjet printer and an ink circulation method and an initial ink installation method used in the printer.

2. Description of the Background Art

Inkjet printers have been conventionally used to each print on a printing medium by scanning the printing medium with its head in which a plurality of outlets for ejecting fine droplets of ink are arranged. Also well known are printers each of which prints while circulating ink between an ink tank storing ink and a head. In a printing apparatus shown in Japanese Patent Application Laid Open No. 2006-289955 (Document 1), for example, circulation of ink is performed where ink is fed from an ink tank to an inkjet head by pressure of a pump and the ink is returned from the inkjet head to the ink tank through another ink outlet passage. In a printing apparatus shown in International Publication No. WO 00/38928 (Document 2), circulation of ink is performed where ink is supplied from a lower container positioned below a print head, being open to the air, to an upper container positioned above the print head, being open to the air, by a pump and the ink is returned from the upper container to the lower container through the print head.

In a printing apparatus in which circulation of ink is performed, even if air bubbles appear in the ink in a head (in a piezoelectric driving type head, for example, oscillation caused by high-speed driving of piezoelectricity sometimes causes air bubbles in ink), it is possible to return the air bubbles together with the ink to an ink tank and this suppresses the occurrence of a state where air bubbles move to outlets of the head to temporarily block ejection of ink from the outlets (the occurrence of the so-called missing nozzle). Further, circulation of ink can also resolve the precipitation of pigment which often occurs when white ink is used, and the like.

When ink is fed from an ink tank to a head by pressure of a pump, like in the printing apparatus shown in Document 1, however, the flow of ink moving in the head significantly varies due to the effect of pulsation of the pump and the like and the pressure of ink at the outlets thereby varies. This causes the landing positions on a printing medium and the like of ink with respect to the outlets (i.e., relative landing positions of fine droplets of ink on the printing medium with respect to the positions of the outlets in ejection of the fine droplets) to vary. Further, in the printing apparatus shown in Document 2, since an ink tank is open to the air, the amount of dissolved air in ink becomes larger. This makes it easy to cause air bubbles in ink, and therefore, even in an ink circulation system, the possibility of causing troubles in ink ejection increases.

### SUMMARY OF THE INVENTION

The present invention is intended for an inkjet printer, and it is an object of the present invention to provide a new technique to allow an appropriate circulation of ink while degassing the ink.

According to the present invention, the printer comprises a head for ejecting droplets of ink from a plurality of outlets arranged in an arrangement direction onto a printing medium which moves relatively to the plurality of outlets in a direction crossing the arrangement direction, a first ink tank storing ink in the vicinity of the head, being connected to the head, a second ink tank storing ink, being connected to the first ink tank through a supply line and connected to the head through a return line, a pump provided in the supply line, for supplying the first ink tank with ink stored in the second ink tank, and a decompressor for decompressing the inside of the second ink tank, to return ink from the first ink tank to the second ink tank through a passage which leads from the first ink tank to the second ink tank via the head, with the passage filled with ink.

In the printer of the present invention, by using the negative pressure inside the second ink tank, it is possible to appropriately circulate ink while degassing the ink in the second ink tank.

According to a preferred embodiment of the present invention, the printer further comprises another decompressor for decompressing the inside of the first ink tank, and in the printer of the present invention, menisci of ink are formed in the plurality of outlets in a state where the inside of the first ink tank is decompressed by the another decompressor. This makes the pressure of ink at the outlets negative pressure, thereby preventing a leak of ink from the outlets.

According to another preferred embodiment of the present invention, the printer further comprises another head which has the same structure as the head, and in the printer of the present invention, the head and the another head are connected to the first ink tank in parallel and connected to the return line in parallel. This allows ink to be ejected from the plurality of heads under the same condition.

According to still another preferred embodiment of the present invention, a pressure inside the second ink tank is kept almost constant by the decompressor. This makes the pressure of ink at the outlets of the head constant, thereby suppressing the variation of the landing positions and the like of ink with respect to the outlets.

The present invention is also intended for an ink circulation method used in an inkjet printer. The printer comprises a head for ejecting droplets of ink from a plurality of outlets arranged in an arrangement direction onto a printing medium which moves relatively to the plurality of outlets in a direction crossing the arrangement direction, a first ink tank storing ink in the vicinity of the head, being connected to the head, a second ink tank storing ink, being connected to the first ink tank through a supply line and connected to the head through a return line and a pump provided in the supply line, and the ink circulation method comprises the steps of a) supplying the first ink tank with ink stored in the second ink tank by driving the pump, and b) returning ink from the first ink tank to the second ink tank through a passage which leads from the first ink tank to the second ink tank via the head, with the passage filled with ink, by decompressing the inside of the second ink tank.

The present invention is further intended for an initial ink installation method used in an inkjet printer. The printer comprises a head for ejecting droplets of ink from a plurality of outlets arranged in an arrangement direction onto a printing medium which moves relatively to the plurality of outlets in a direction crossing the arrangement direction, a first ink tank storing ink above and in the vicinity of the head, being connected to the head, a second ink tank storing ink, being connected to the first ink tank through a supply line and connected to the head through a return line, a pump provided in the supply line, for supplying the first ink tank with ink stored in the second ink tank, a decompressor for decompressing the inside of the second ink tank, to return ink from the first ink tank to the second ink tank through a passage which leads from the first ink tank to the second ink tank via the head, with the passage filled with ink, a flow limiting part provided in the return line, for limiting flow of ink, a valve provided between the flow limiting part and the second ink tank in the return line and an auxiliary passage having one end connected to an uppermost part of the return line or in the vicinity of the uppermost part, the uppermost part being positioned upper than the liquid surface of ink stored in the first ink tank and positioned between the head and the valve in the return line, and the initial ink installation method comprise the steps of a) filling a part of the passage which leads from the first ink tank to the valve with ink by storing the ink in the first ink tank and decompressing the inside of the auxiliary passage with the valve closed, to cause the ink to flow into the auxiliary passage without inflow of air from the plurality of outlets, and b) filling the whole of the passage with the ink by closing the auxiliary passage at the position where the ink exists, opening the valve and driving the decompressor. When the circulation of ink is started, since this prevents any gas from remaining in part of the passage leading from the first ink tank to the second ink tank via the head, on the side of the first ink tank viewed from the valve, it is possible to prevent any trouble in ejection of ink due to the sucking of air from the outlets into the head.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a basic construction of a head unit and an ink circulation mechanism;

FIG. 2 is a perspective view showing an appearance of a printer;

FIG. 3 is a bottom plan view showing an ejection part;

FIG. 4 is a view showing a construction of the head unit and the ink circulation mechanism;

FIG. 5 is a flowchart showing an operation flow of initially installing ink into the printer;

FIGS. 6A and 6B are flowcharts showing a flow of ink filling operation for the first ink tank;

FIG. 7 is a flowchart showing an operation flow of ink circulation in the printer;

FIG. 8 is a view showing the vicinity of the first ink tank;

FIG. 9 is a view showing the vicinity of the second ink tank;

FIG. 10 is a flowchart showing an operation flow of degassing;

FIG. 11 is a view showing part of another exemplary printer;

FIG. 12 is a graph for explanation on an operation of forcedly ejecting ink from the outlets;

FIG. 13 is a view showing another exemplary ink circulation mechanism; and

FIG. 14 is a view showing still another exemplary printer.

### DESCRIPTION OF THE PREFERRED EMBODIMENTS

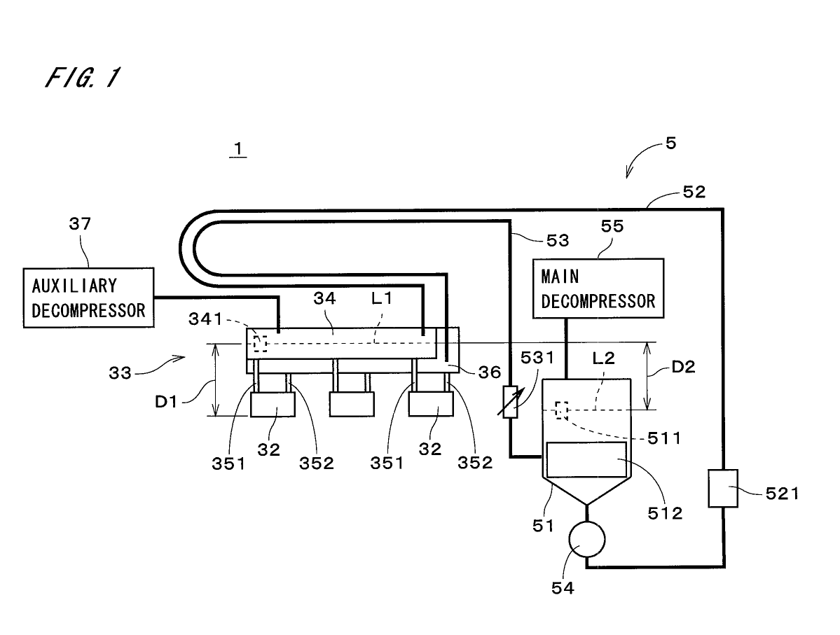

First, discussion will be made on a basic principle of ink circulation in a printer in accordance with one preferred embodiment of the present invention. FIG. 1 is a view showing a construction of part of a printer 1, illustrating a basic construction of a head unit 33 and an ink circulation mechanism 5. To the ink circulation mechanism in the printer 1, actually, a plurality of head units 33 are connected.

As shown in FIG. 1, the head unit 33 comprises a plurality of heads 32 each having a plurality of outlets on its lower surface, a first ink tank 34 storing ultraviolet curable ink above and in the vicinity of the plurality of heads 32, a plurality of ink inlet pipes 351 for causing flow of ink from the first ink tank 34 to the plurality of heads 32, respectively, a manifold main body 36 provided in two tiered structure with the first ink tank 34 above the plurality of heads 32, forming an internal space into which ink flows from the plurality of heads 32 and a plurality of ink outlet pipes 352 connecting the plurality of heads 32 and the manifold main body 36, respectively.

The ink circulation mechanism 5 comprises a second ink tank 51 storing ink, and the second ink tank 51 is connected to the first ink tank 34 through a supply line 52 and also connected to the plurality of heads 32 through a return line 53, the manifold main body 36 in the head unit 33 and the plurality of ink outlet pipes 352. The supply line 52 is provided with a pump 54 and a filter 521, and with the pump 54, ink stored in the second ink tank 51 is supplied to the first ink tank 34 and stored therein while unnecessary substances in the ink are removed through the filter 521. The area of cross section in a horizontal plane of the internal space in the second ink tank 51 is almost constant in a vertical direction (the same applies to the first ink tank 34), and the cross-sectional area of the second ink tank 51 is larger than that of the first ink tank 34. Long supply line 52 and return line 53 are used to allow the head unit 33 to move in parallel toward the left side in FIG. 1 (the opposite side of the second ink tank 51) in maintenance and the like.

To the second ink tank 51, a main decompressor 55 having a pump, a pressure regulating valve, a pressure gauge and the like is connected, and the main decompressor 55 reduces a pressure (of gas) inside the second ink tank 51 to become a pressure (hereinafter, referred to as a “normal circulation pressure”) lower than the atmosphere pressure by several hundred millibar (mbar) (e.g., 500 mbar (i.e., 5×10⁴ pascal (Pa))), to thereby return ink from the first ink tank 34 to the second ink tank 51 through a passage (hereinafter, referred to as a “return passage”) leading from the first ink tank 34 to the second ink tank 51 via the plurality of ink inlet pipes 351, the plurality of heads 32, the plurality of ink outlet pipes 352, the manifold main body 36 and the return line 53, with the return passage filled with ink.

The return line 53 is provided with a flow regulating valve 531 serving as a flow limiting part to limit the flow of ink from the first ink tank 34 to the second ink tank 51 in accordance with the area of an opening (hereinafter, referred to as a “passage opening”) serving as a passage inside the flow regulating valve 531. In a normal operation of the preferred embodiment, since the area of the passage opening in the flow regulating valve 531 is not changed, the flow rate of ink from the first ink tank 34 to the second ink tank 51 mainly depends on the pressure inside the second ink tank 51 (exactly, the difference in pressure between the first ink tank 34 and the second ink tank 51). In the ink circulation mechanism 5, since the main decompressor 55 controls the pressure inside the second ink tank 51 to be almost constant, the flow rate of ink in the heads 32 is made almost constant with time. Further, depending on the design of the printer 1, a thin tube capable of causing the same pressure loss as the flow regulating valve 531 does may be provided as the flow limiting part instead of flow regulating valve 531.

Though the flow rate of ink, actually, also depends on the position of a liquid surface of ink in the first ink tank 34, since the specific gravity of ink used in the preferred embodiment is almost 1 and variation of the position of the liquid surface of ink is controlled to fall within the range of ±several millimeter (mm) in the printer 1, the variation of the position of the liquid surface of ink corresponds to only pressure variation less than ±1 mbar. Therefore, the effect of the variation in the position of the liquid surface of ink in the first ink tank 34 on the flow rate of ink is very small, as compared with the pressure variation in the second ink tank 51, enough to be ignored.

In the plurality of heads 32 of the printer 1, which are connected in parallel to the first ink tank 34 and connected in parallel to the return line 53 through the manifold main body 36, resistances (pressure losses) of the respective passages leading from the ink inlet pipes 351 to the ink outlet pipes 352 via the heads 32 are equal to one another, and the flow rates of ink are in the plurality of heads 32 equal to one another. This allows the plurality of heads 32 to eject ink under the same condition.

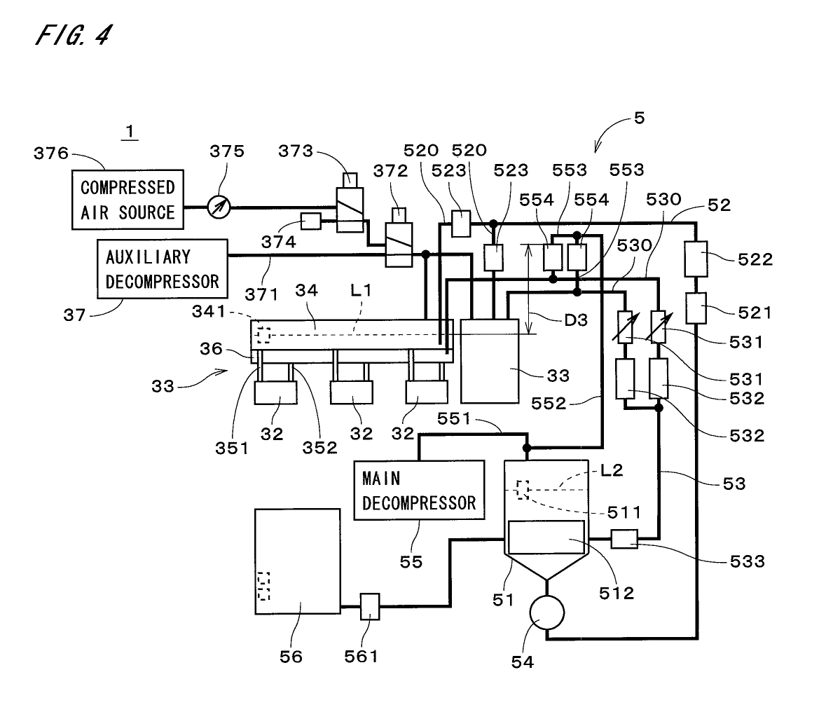

The first ink tank 34 and the second ink tank 51 are provided with ink level sensors 341 and 511, respectively, for each detecting the position of the liquid surface of ink (i.e., ink level). In the first ink tank 34 and the second ink tank 51, set are predetermined preset ink levels (indicated by broken lines L1 and L2, respectively, in FIG. 1) and replenishment end levels indicating the upper limits and replenishment start levels indicating lower limits with the respective preset ink levels as center positions. As discussed later, in the first ink tank 34, when the position of the liquid surface of ink becomes equal to or lower than the replenishment start level, ink is replenished (supplied) from the second ink tank 51 by the pump 54, and in the second ink tank 51, when the position of the liquid surface of ink becomes equal to or lower than the replenishment start level, ink is replenished from a main ink tank 56 of FIG. 4 described later.

Further, the second ink tank 51 is provided with a heater 512 and a temperature sensor (not shown) for heating ink up to a predetermined temperature (e.g., 45° C.) so that the viscosity of ink is reduced to be lower than that in a room temperature. Actually, the head 32 is provided with a driver circuit, and the driver circuit is cooled since ink whose temperature is controlled passes the head 32. This reduces the manufacturing cost of the printer 1, as compared with a case of providing a separate cooling mechanism.

To the first ink tank 34, an auxiliary decompressor 37 having a pump, a pressure regulating valve, a pressure gauge and the like is connected, and the auxiliary decompressor 37 reduces a pressure (of gas) inside the first ink tank 34 to become a pressure (hereinafter, referred to as a “normal auxiliary-pressure”) lower than the atmosphere pressure by several mbar (in other words, the pressure inside the first ink tank 34 becomes a slightly negative pressure). In a case, for example, where a pressure of ink at each of the outlets of the head 32 is made lower than the atmosphere pressure by a mbar to form meniscus of ink in the outlet, when the difference in height in the vertical direction between the preset ink level L1 of ink in the first ink tank 34 and the outlet (the difference is indicated by an arrow D1 in FIG. 1) is β centimeter (cm), since the specific gravity of ink used in the printer 1 is almost 1, the inside of the first ink tank 34 is decompressed by the auxiliary decompressor 37 so that the pressure in the first ink tank 34 may become lower than the atmosphere pressure by (β+α) mbar.

In the printer 1, in the state where the inside of the first ink tank 34 is thus decompressed, the pressure of ink at the plurality of outlets of each head 32 becomes negative pressure and menisci of ink are formed in the outlets to prevent a leak of ink from the outlets. Since the pressure loss (passage resistance) in the ink inlet pipe 351 which is a passage between the first ink tank 34 and the head 32 is much smaller than that of the passage between the head 32 and the second ink tank 51, the negative pressure in the second ink tank 51 has almost no effect on the pressure of ink at the outlets.

Further, in the above case where the pressure in the first ink tank 34 is lower than the atmosphere pressure by (β+α) mbar, by setting the difference in height between the preset ink level L1 of ink in the first ink tank 34 and the preset ink level L2 of ink in the second ink tank 51 (the difference is water head difference indicated by an arrow D2 in FIG. 1) to (β+α) cm, it becomes possible to prevent (or suppress) the movement of ink from the first ink tank 34 to the second ink tank 51 even if the pressure inside the second ink tank 51 becomes the atmosphere pressure due to an abnormal condition of the main decompressor 55. Naturally, if the supply line 52 and the return line 53 are provided with emergency block valves for cut off the passages, respectively, in the abnormal condition, such a design as to provide the above water head difference is not needed.

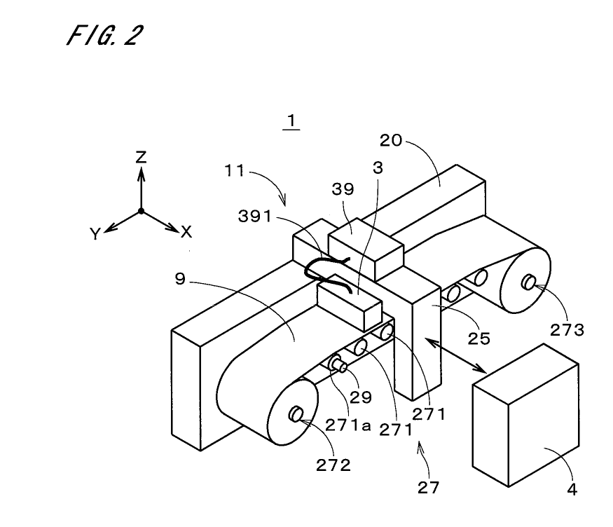

Next, an overall structure of the printer 1 of FIG. 1 will be discussed. FIG. 2 is a perspective view showing an appearance of the printer 1. The printer 1 performs color printing on a sheet-like liquid-repellent base material 9 such as film in an inkjet manner. In FIG. 2, the ink circulation mechanism 5 is not shown.

The printer 1 of FIG. 2 comprises a main body 11 and a control part 4, and the main body 11 comprises a feeder 27 for moving the sheet-like base material 9 in the Y direction (hereinafter, referred to also as “scan direction”) of FIG. 2 and an ejection part 3 for ejecting fine droplets of ink onto the base material 9 while the base material 9 is being moved by the feeder 27. In the feeder 27, a plurality of rollers 271 each of which is long in the X direction of FIG. 2 are arranged in the Y direction, and on the (+Y) side of the plurality of rollers 271, a supplying part 272 for holding a roll-like base material 9 (feed roll) is provided and on the (−Y) side of the plurality of rollers 271, a winding part 273 for holding a roll-like base material 9 (wind-up roll) is provided. In the following discussion, when simply referred to as the base material 9, it refers to a part of the base material 9 which is being moved (in other words, a part of the base material 9 which is positioned on the plurality of rollers 271).

One of the rollers, 271a, in the feeder 27 is provided with an encoder 29 for detecting a movement speed of the base material 9 in the scan direction, and the control part 4 controls the rotation of a motor of the winding part 273 on the basis of an output of the encoder 29, to thereby move the base material 9 in the (−Y) direction at a constant speed. Actually, a motor of the supplying part 272 gives a load (tension) in a direction opposite to a moving direction (i.e., in the (+Y) direction) to the base material 9, to thereby smoothly move the base material 9 on the plurality of rollers 271 without waving.

The ejection part 3 is disposed above the plurality of rollers 271 (on the (+Z) side of FIG. 2) and fixed onto a frame 25 provided on a base 20, being across the plurality of rollers 271. On the frame 25, a light source 39 for emitting ultraviolet rays is provided and light emitted from the light source 39 is led into the ejection part 3 through a plurality of optical fibers (actually, the plurality of optical fibers are made into a bundle and indicated by one thick line with reference numeral 391 in FIG. 2).

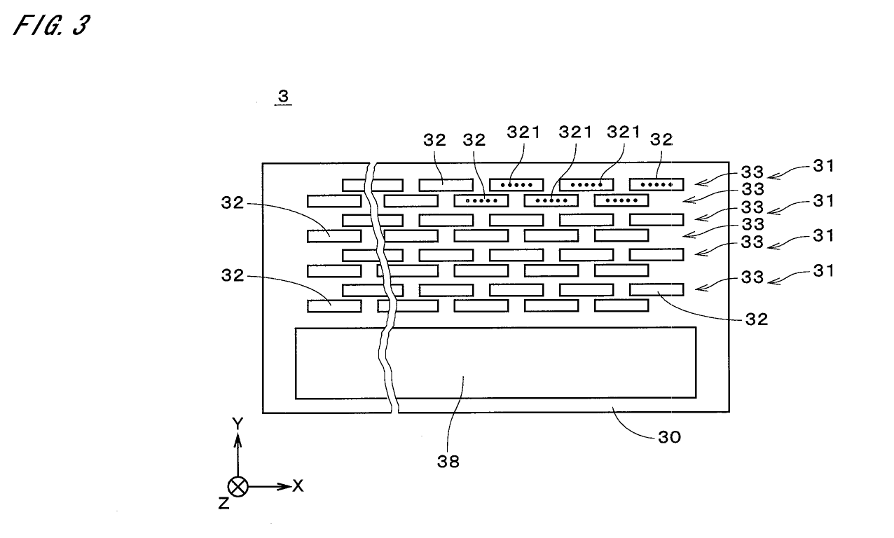

FIG. 3 is a bottom plan view showing the ejection part 3. As shown in FIG. 3, the ejection part 3 comprises a plurality of head groups 31 (four head groups 31 in FIG. 3) for ejecting ink of different colors, and the plurality of head groups 31 are arranged in the Y direction and fixed to a body 30 of the ejection part 3. In FIG. 3, the first head group 31 on the (+Y) side ejects ink of K (black), the head group 31 adjacent to the head group 31 of K on the (−Y) side ejects ink of C (cyan), the head group 31 adjacent to the head group 31 of C on the (−Y) side ejects ink of M (magenta) and the first head group 31 on the (−Y) side ejects ink of Y (yellow). The ink of each color includes an ultraviolet curing agent and is ultraviolet curable. The ejection part 3 may be further provided with head groups 31 of other colors, e.g., light cyan, light magenta, white and the like.

In each of the head groups 31, the plurality of heads 32 are arranged in a staggered manner in the X direction (a direction orthogonal to the Y direction and the Z direction, and hereinafter, referred to as a “width direction”) in FIG. 3, and in each of the heads 32, the plurality of outlets (the outlets in some heads 32 are represented by dots with reference numeral 321) are formed and arranged in the width direction. In the head groups 31, on the whole, a lot of outlets 321 are arranged at a constant pitch in the width direction which is an arrangement direction, to thereby allow formation of a plurality of dots aligned in the width direction at each position on the base material 9 in the scan direction. Actually, the plurality of outlets 321 in each of the head groups 31 are provided entirely in a printing area on the base material 9 with respect to the width direction (herein, almost entirely in the width in the width direction of the base material 9), and with only one pass of the base material 9 below the ejection part 3, printing of an image on the base material 9 is completed (so-called one-pass printing).

In the ejection part 3 of FIG. 3, a light emitting part 38 connected to the light source 39 is provided on the (−Y) side of the plurality of head groups 31. In the light emitting part 38, a plurality of optical fibers are arranged along the X direction and ultraviolet rays are emitted from the light emitting part 38 onto a linear area extending in the X direction on the base material 9.

In the printer 1, with respect to each color, the plurality of heads 32 aligned in the width direction constitute one head unit 33 and the plurality of head units 33 (two head units 33 in FIG. 3) are arranged in the scan direction, to form an arrangement of heads 32 in each head group 31. The plurality of head units 33 are connected in parallel to the ink circulation mechanism 5 (see FIG. 4 discussed later), and with the ink circulation mechanism 5, ink is supplied to the plurality of heads 32 in each head unit 33 and returned from the head unit 33. In the following discussion, though attention is paid to the head units 33 for one color out of the plurality of colors and the ink circulation mechanism 5 for the one color, the same applies to the head units and the ink circulation mechanisms of other colors.

FIG. 4 is a view showing a construction of the head units 33 and the ink circulation mechanism 5. As discussed earlier, the printer 1 is provided with the plurality of head units 33 (two head units 33 are shown in FIG. 4, and one of the head units 33 is simply represented by a rectangle).

As discussed earlier referring to FIG. 1 which is a simplified view of FIG. 4, the ink circulation mechanism 5 has the second ink tank 51 storing ink, to which the supply line 52 and the return line 53 are connected. One side of the supply line 52 opposite to the second ink tank 51 branches into a plurality of supply branch lines 520 which are connected to the first ink tanks 34 of the plurality of head units 33, respectively and each of the supply branch lines 520 is provided with a valve 523. A filter 521 and a deaerator 522 are provided between a branch point of the supply line 52 and the pump 54.

Further, one side of the return line 53 opposite to the second ink tank 51 also branches into a plurality of return branch lines 530 and the plurality of return branch lines 530 are connected to the respective manifold main bodies 36 of the plurality of head units 33. Each of the return branch lines 530 is provided with the flow regulating valve 531 and a flow measurement part 532 for measuring the flow rate of ink. In this preferred embodiment, before the actual use of the printer 1, by regulating the flow regulating valve 531 on the basis of a measured value of the flow measurement part 532, the respective flow rates of ink in the plurality of return branch lines 530 are set equal. In the return line 53, a valve (hereinafter, referred to as a “return line valve”) 533 is provided in the vicinity of the second ink tank 51.

To a decompression pipe 551 between the second ink tank 51 and the main decompressor 55, connected is one end of an auxiliary passage 552 used for an initial installation of ink discussed later. The other end of the auxiliary passage 552 branches into a plurality of auxiliary branch passages 553 and the plurality of auxiliary branch passages 553 are connected to the plurality of return branch lines 530, respectively. In more detail, an uppermost part of each of the return branch lines 530 is positioned upper than the liquid surface of ink stored in the first ink tank 34 and the auxiliary branch passage 553 is connected to the uppermost part or in the vicinity thereof. Further, each of the auxiliary branch passage 553 is provided with a valve 554.

To the second ink tank 51, the main ink tank 56 is further connected via a valve 561, and ink is replenished into the second ink tank 51 from the main ink tank 56 as necessary.

To the auxiliary decompressor 37 connected is one end of a decompression pipe 371, and the other end of the decompression pipe 371 branches into a plurality of pipes which are connected to the respective first ink tanks 34 in the plurality of head units 33. A first switching valve 372 is provided between the auxiliary decompressor 37 and the branch point in the decompression pipe 371 and this makes the first ink tanks 34 connectable to either a passage connected to the auxiliary decompressor 37 or another passage. In another passage, a second switching valve 373 is provided and this makes it possible to switch between a passage which is open to the air through a filter 374 and a passage connected to a compressed air source 376 through a regulator 375.

Thus, with the first and second switching valves 372 and 373, the first ink tank 34 is in any one of the states where being connected to the auxiliary decompressor 37, the inside thereof is decompressed, where being connected to the filter 374, a pressure inside it is brought into the atmosphere pressure and where being connected to the compressed air source 376, the inside thereof is pressurized. The compressed air source 376 has a pump and a filter, and compressed air from the compressed air source 376 is regulated by the regulator 375 to such a pressure as not to damage the outlets of the heads 32.

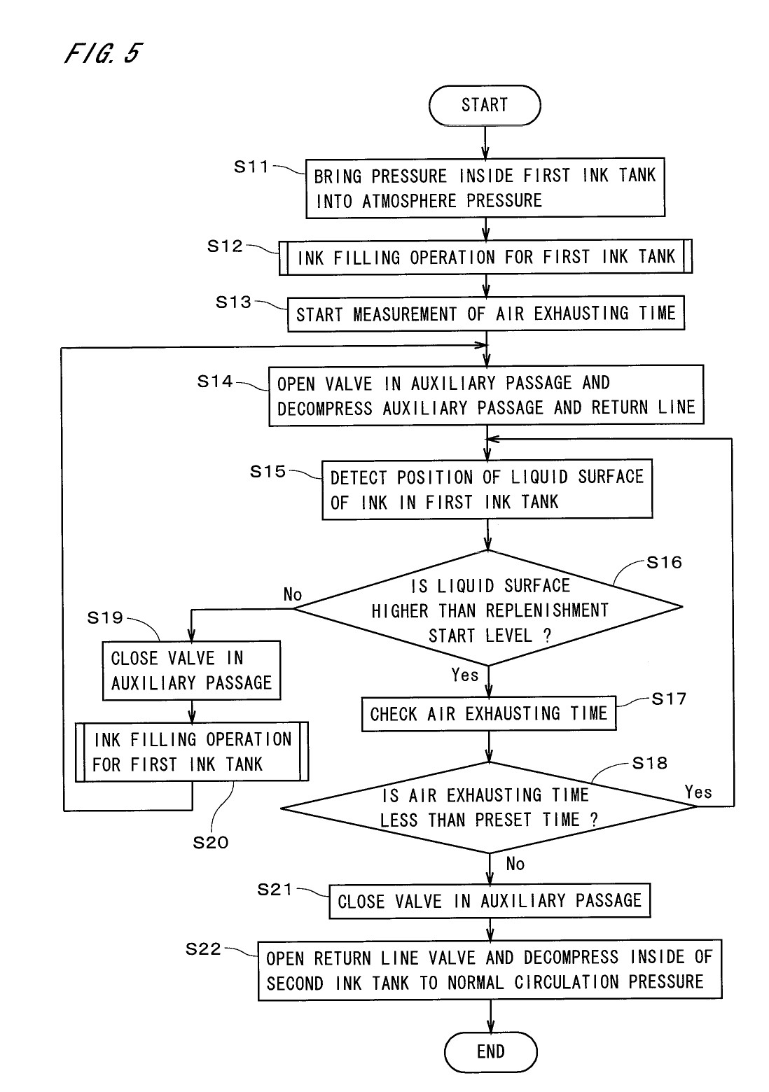

Next, discussion will be made on a technique of installing ink to the first ink tank 34, the second ink tank 51 and the heads 32 for the first time in the printer 1. FIG. 5 is a flowchart showing an operation flow of initially installing ink into the printer 1.

In the printer 1, first, with the first and second switching valves 372 and 373, a pressure inside the first ink tanks 34 is brought into the atmosphere pressure (Step S11) and subsequently performed is an operation of filling the first ink tanks 34 with ink (Step S12).

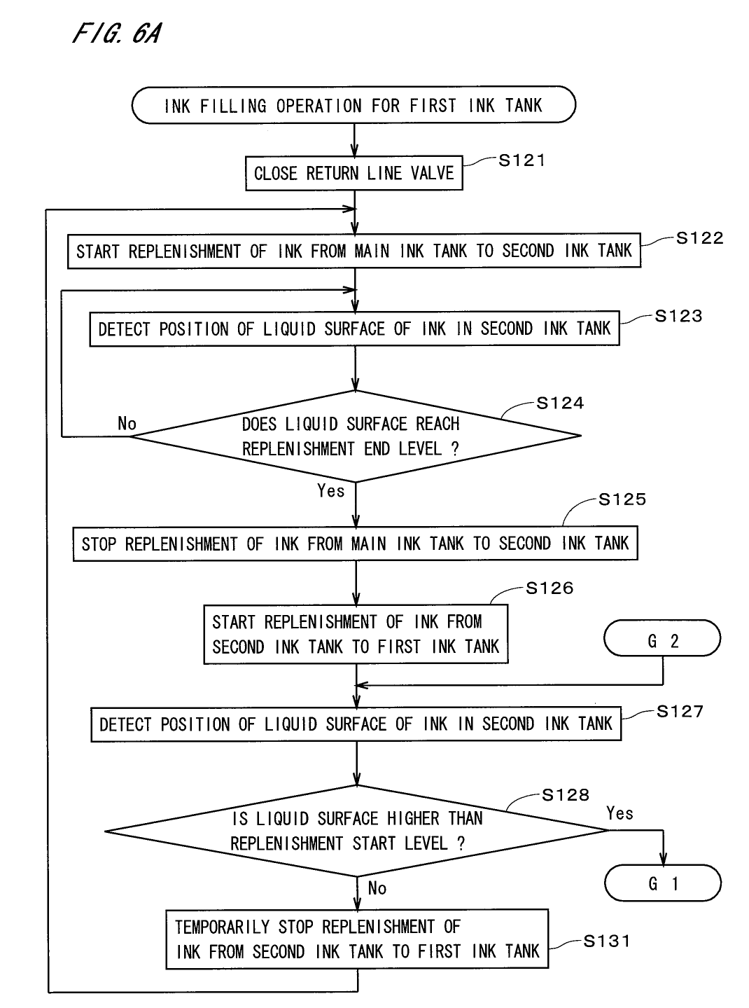

FIGS. 6A and 6B are flowcharts showing a flow of ink filling operation for the first ink tanks 34, which is the operation performed in Step S12 of FIG. 5. In the ink filling operation, first, the return line valve 533 provided between the flow regulating valve 531 and the second ink tank 51 in the return line 53 is closed (Step S121), and subsequently, the main decompressor 55 decompresses the inside of the second ink tank 51 to a predetermined pressure (e.g., the normal circulation pressure) and a valve 561 provided between the main ink tank 56 and the second ink tank 51 is opened. With this, ink stored in the main ink tank 56 moves to the second ink tank 51 and replenishment of ink from the main ink tank 56 to the second ink tank 51 is started (Step S122). At that time, since the return line valve 533 is provided in the vicinity of the second ink tank 51, a part of the return line 53 which is positioned between the return line valve 533 and the second ink tank 51 is filled with ink. In other words, the air existing in this part moves into the second ink tank 51.

In the control part 4, the position of the liquid surface of ink in the second ink tank 51 is repeatedly detected on the basis of an output from the ink level sensor 511 of the second ink tank 51 (Steps S123 and S124), and when it is found that the liquid surface of ink reaches the replenishment end level higher than the preset ink level L2 (Step S124), the valve 561 is closed, decompression of the second ink tank 51 by the main decompressor 55 is stopped, and then the pressure inside the second ink tank 51 is made the atmosphere pressure. With this, replenishment of ink from the main ink tank 56 to the second ink tank 51 is finished (Step S125).

Subsequently, the respective valves 523 of the plurality of supply branch lines 520 are opened and driving of the pump 54 is started. With this, the ink stored in the second ink tank 51 moves to the respective first ink tanks 34 of the plurality of head units 33 through the supply line 52 and replenishment of ink from the second ink tank 51 to the first ink tanks 34 is started (Step S126). At that time, since the respective valves 554 of the plurality of auxiliary branch passages 553 are opened, the ink in the first ink tank 34 of each head unit 33 is filled through the plurality of ink inlet pipes 351 (in FIG. 4, reference numeral 351 is given only to one ink inlet pipe and reference numeral 352 is given only to one ink outlet pipe), the plurality of heads 32, the plurality of ink outlet pipes 352 up to the manifold main body 36 and a liquid surface of ink is formed at the same level as the liquid surface of ink in the first ink tank 34 at a part of the return branch line 530 extending upward from the manifold main body 36 in the vertical direction. Further, a dedicated receiver is provided below the head unit 33 and therefore no problem arises even if ink runs from the outlets.

While the replenishment of ink to the first ink tank 34 is performed, the position of the liquid surface of ink in the second ink tank 51 provided below is detected on the basis of an output from the ink level sensor 511 (Step S127), and when it is found that the liquid surface of ink is higher than the replenishment start level which is positioned lower than the preset ink level L2 (Step S128), the position of the liquid surface of ink in the first ink tank 34 provided above is detected on the basis of an output from the ink level sensor 341 of the first ink tank 34 (Step S129). When it is found that the liquid surface of ink is lower than the replenishment end level which is positioned higher than the preset ink level L1 (Step S130), the position of the liquid surface of ink in the second ink tank 51 is detected again (Step S127). Thus, while the replenishment of ink to the first ink tank 34 is performed, the operations of Steps S127 to S130 are repeated.

At that time, when it is found that the height of the liquid surface of ink in the second ink tank 51 becomes equal to or lower than the replenishment start level by the movement (flow) of ink from the second ink tank 51 to the first ink tank 34 (Steps S127 and S128), the valves 523 of the plurality of supply branch lines 520 are temporarily closed and the pump 54 is stopped and this temporarily stops the replenishment of ink from the second ink tank 51 to the first ink tank 34 (Step S131). Then, by performing the operations of Steps S122 to S125, ink is replenished from the main ink tank 56 to the second ink tank 51 and after that, the supply of ink from the second ink tank 51 to the first ink tank 34 is resumed (Step S126) and the operations of Steps S127 to S130 are repeated.

In the printer 1, when it is found that the liquid surface of ink in the first ink tank 34 of each head unit 33 reaches the replenishment end level (Step S129 and S130), the valves 523 of the plurality of supply branch lines 520 are closed and the pump 54 is stopped and this stops the replenishment of ink from the second ink tank 51 to the first ink tank 34 (Step S132).

When the first ink tank 34 is thus filled with ink (Step S12 of FIG. 5), the control part 4 starts to measure the time (the air exhausting time discussed later) (Step S13), and at the same time, the valves 554 of the plurality of auxiliary branch passages 553 are opened and the main decompressor 55 starts decompression. With this, the inside of the auxiliary passage 552 including the auxiliary branch passages 553 and the inside of the return line 53 including the return branch lines 530 (except the part between the return line valve 533 and the second ink tank 51) are decompressed and ink flows into the return line 53 (Step S14).

In the printer 1, at that time, the plurality of auxiliary branch passages 553 are provided so as to extend upward from respective uppermost parts of the plurality of return branch lines 530 in the vertical direction, and the plurality of valves 554 are disposed at the same level, and the main decompressor 55 decompresses the inside of the second ink tank 51 and the auxiliary passage 552 to an initial installation pressure so that the liquid surface of ink may be formed above the open/close position of the valve 554 in each auxiliary branch passage 553 (in other words, the position to open or close a passage inside the valve 554). Actually, since the specific gravity of the ink used in this preferred embodiment is almost 1 and the pressure in the first ink tank 34 is brought into the atmosphere pressure by the operation of Step S11, when the difference in height in the vertical direction between the position of liquid surface formed in the auxiliary branch passage 553 and the position of the liquid surface in the first ink tank 34 (indicated by an arrow D3 in FIG. 4) is γ cm, the initial installation pressure in the auxiliary passage 552 is lower than the atmosphere pressure by γ mbar. Further, the initial installation pressure is sufficiently higher than the normal circulation pressure.

When the position of the liquid surface of ink in the first ink tank 34 is detected (Step S15) and it is found that the liquid surface of ink is higher than the replenishment start level lower than the preset ink level L1 (Step S16), the control part 4 checks the time period after the time measurement is started in Step S13 (in other words, the time period after the decompression of the auxiliary passage 552 and the return line 53 is started and hereinafter, referred to as “air exhausting time”) (Step S17), and if the air exhausting time is shorter than a preset time which is set in advance (Step S18), back to Step S15, the position of the liquid surface of ink in the first ink tank 34 is detected. Thus, in the printer 1, the check of the position of the liquid surface of ink in the first ink tank 34 and the comparison between the air exhausting time and the preset time are repeatedly performed (Steps S15 to S18).

At that time, if it is found that the level of the liquid surface of ink is equal to or lower than the replenishment start level (Steps S15 and S16), the valves 554 of the plurality of auxiliary branch passages 553 are temporarily closed (Step S19) and the ink filling operation for the first ink tank 34 like in Step S12 is performed (Step S20) (unnecessary operations, however, may be omitted as appropriate). Then, when the first ink tank 34 is filled with ink, the valves 554 of the plurality of auxiliary branch passages 553 are opened again and the inside of the auxiliary passage 552 and the inside of the return line 53 are decompressed (Step S14), and the operations of Steps S15 to S18 are repeated. Further, while the valves 554 of the auxiliary branch passages 553 are closed, the measurement of the air exhausting time is temporarily stopped.

Then, when the air exhausting time equals or exceeds the preset time (Steps S17 and S18), the valves 554 of the plurality of auxiliary branch passages 553 are closed (Step S21). Thus, the inside of the auxiliary passage 552 is decompressed to the initial installation pressure and the state where the liquid surface of ink is formed in each auxiliary branch passage 553 continues for some time, and this evacuates air from the part of the return line 53 which leads from the first ink tank 34 to the return line valve 533 so that the part is filled with ink. As discussed earlier, since the initial installation pressure is slightly lower than the atmosphere pressure (in other words, a low negative pressure), meniscus of ink is formed at each outlet of the head 32 and no air flows from the outlet into the head 32.

Subsequently, by opening the return line valve 533 and using the main decompressor 55 to decompress the inside of the second ink tank 51 to the normal circulation pressure, the movement (flow) of ink into the second ink tank 51 from the first ink tanks 34 of the head units 33 starts and the initial installation of ink is completed (Step S22). At that time, even if air remains in the part of the return line 53 which is positioned between the return line valve 533 and the second ink tank 51, this air flows into the second ink tank 51 together with the ink. As discussed later, if circulation of ink is performed subsequently to the initial installation of ink, after a certain time elapsed from the time when the pressure inside the second ink tank 51 is brought into the normal circulation pressure, the auxiliary decompressor 37 decompresses the inside of each first ink tank 34 to the normal auxiliary-pressure.

If the pressure inside the second ink tank 51 is brought into the normal circulation pressure and the movement of ink from the first ink tank 34 to the second ink tank 51 is started in a state where relatively much air remains in the return line 53, when this air passes the flow regulating valve 531, the pressure of ink on the side of the second ink tank 51 viewed from the flow regulating valve 531 is transferred to the ink on the side of the heads 32 viewed from the flow regulating valve 531 and the pressure of ink at the outlets of the heads 32 becomes excessively low. At that time, when the pressure of ink at the outlet becomes lower than the atmosphere pressure by several tens of mbar or more (when the difference between the pressure of ink and the atmosphere pressure becomes 10 mbar or more, depending on the design of the printer 1), no meniscus of ink is formed at the outlet and outside air is sucked into the head 32 together with particles therearound, and this causes a trouble in ejection of ink (for example, missing nozzle or deviation which is a tilt of the ejecting direction of ink). Further, the inside air blocks the flow of ink and this sometimes causes a hindrance to the cooling of the driver circuit by ink. Furthermore, the heater 512 heats ink up to a certain temperature in the second ink tank 51 to expand the air in the return line 53, and this sometimes causes the above phenomenon.

In contrast to this, in the printer 1, when the pressure inside the second ink tank 51 is brought into the normal circulation pressure and the movement of ink is started in the return passage leading from the first ink tank 34 to the second ink tank 51 via the heads 32 (in other words, when the return line valve 533 is opened), since the initial ink installation shown in FIG. 5 prevents air from remaining in the return passage on the side of the first ink tank 34 viewed from the return line valve 533, it is possible to prevent any trouble in ejection of ink due to the sucking of air from the outlets into the heads 32.

Actually, if very little air remains in the return passage, when the air passes the flow regulating valve 531, the pressure of ink at the outlet of the head 32 decreases only by several mbar. Therefore, when the inside of the first ink tank 34 is kept at the atmosphere pressure for a certain time period after the return line valve 533 is opened and the pressure inside the second ink tank 51 is brought into the normal circulation pressure in Step S22 of FIG. 5, even if the pressure slightly decreases at the outlet immediately after the return line valve 533 is opened, sucking of air from the outlet is prevented. In this case, there may be another technique where the operations for decompressing the inside of the auxiliary passage 552 in Steps S13 to S18 and the operation of moving ink in the return passage in Step S22 are repeatedly performed (the operations of Steps S13 to S18 in the next time are performed without giving the normal auxiliary-pressure), to surely remove the air from the return passage.

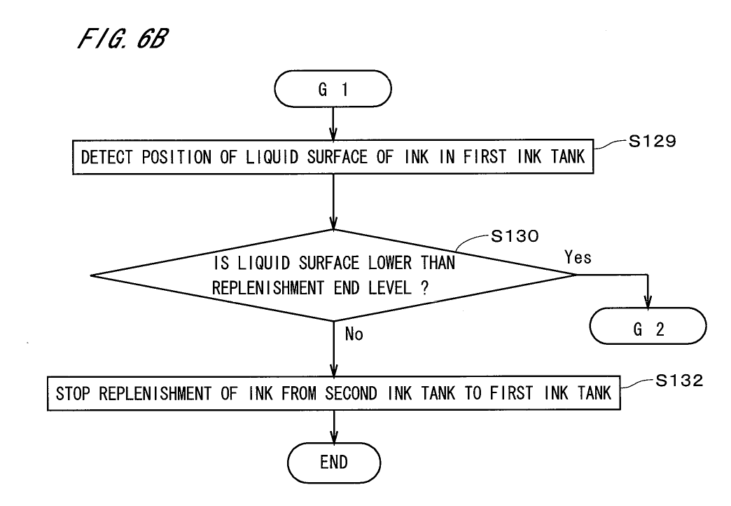

Next, discussion will be made on an operation of the ink circulation mechanism 5 for circulating ink, which is performed after ink is installed into the first ink tanks 34, the second ink tank 51 and all the heads 32. FIG. 7 is a flowchart showing an operation flow of ink circulation in the printer 1.

In the ink circulation, by opening the return line valve 533 and using the main decompressor 55 to decompress the inside of the second ink tank 51 to the normal circulation pressure, the movement of ink from the first ink tanks 34 of the head units 33 to the second ink tank 51 is started, with the return passage leading from the first ink tanks 34 to the second ink tank 51 via the heads 32 filled with ink (Step S31). At that time, the auxiliary decompressor 37 brings the pressure inside each first ink tank 34 into the normal auxiliary-pressure. Further, if the ink circulation is performed subsequently to the above initial ink installation, the operation of Step S22 in FIG. 5 corresponds to that of Step S31.

Further, concurrently with the movement of ink from the first ink tank 34 to the second ink tank 51, the position of the liquid surface of ink in the first ink tank 34 is repeatedly detected on the basis of the output from the ink level sensor 341 (Steps S32 and S33). Then, when it is found that the liquid surface of ink becomes equal to or lower than the replenishment start level by the movement of ink from the first ink tank 34 to the second ink tank 51 (Step S33), the driving of the pump 54 is started in a state where the valves 523 of the plurality of supply branch lines 520 are opened, and the ink stored in the second ink tank 51 is supplied to the first ink tanks 34 of the plurality of head units 33 through the supply line 52.

Concurrently with the supply of ink from the second ink tank 51 to each first ink tank 34, the position of the liquid surface of ink in the first ink tank 34 is repeatedly detected (Steps S35 and S36) and when it is found that the liquid surface of ink reaches the replenishment end level (Step S36), the pump 54 is stopped and the replenishment of ink to the first ink tank 34 is completed (Step S37).

In the ink circulation mechanism 5, concurrently with the continuous movement of ink from the first ink tank 34 to the second ink tank 51, the pump 54 is driven to replenish ink to the first ink tank 34 (Steps S34 to S37) every time when the liquid surface of ink in the first ink tank 34 becomes equal to or lower than the replenishment start level (Steps S38, S32 and S33). Further, in the printer 1, concurrently with the repeated execution of Steps S32 to S37 (Step S38), while the base material 9 is moved in the scan direction, ejection of ink from the plurality of head units 33 is controlled, to perform printing. Actually, in the second ink tank 51, the position of the liquid surface of ink is detected on the basis of the output from the ink level sensor 511, and when the liquid surface of ink becomes equal to or lower than the replenishment start level, ink is replenished from the main ink tank 56 to the second ink tank 51.

Then, after the printing operation of the printer 1 is completed, if it is intended to stop the ink circulation (Step S38), by closing the return line valve 533 and making the inside of the second ink tank 51 open to the air, the movement of ink from the first ink tank 34 to the second ink tank 51 is stopped (Step S39). Further, when it is intended to drive the printer 1 again after the printer 1 is stopped, the initial installation of ink shown in FIG. 5 may be performed in the state where the first ink tanks 34, the second ink tank 51 and the heads 32 are filled with ink, to remove the air bubbles and the like caused in the return line 53 while the printer 1 is stopped.

As discussed above, in the printer 1 of FIG. 4, with the pump 54 driven, ink stored in the second ink tank 51 is supplied to the first ink tank 34 through the supply line 52, and with the inside of the second ink tank 51 decompressed to the negative pressure, the ink is returned from the first ink tank 34 to the second ink tank 51 through the return line 53. With this operation, the negative pressure inside the second ink tank 51 is used to efficiently degas the ink in the second ink tank 51 and this prevents a trouble in ejection of ink, such as ejection failure caused by the presence of air bubbles in ink in the heads 32. Further, since the pressure inside the second ink tank 51 is kept almost constant, it is possible to keep the flow rate of ink flowing in the heads 32 (almost) constant, and this suppresses the variation in loss of pressure in the passage leading from the first ink tank 34, in which the pressure is made the normal auxiliary-pressure, to the vicinity of the outlets of the heads 32, to thereby allow the pressure (static pressure) of ink at the outlets of the heads 32 to be kept constant. As a result, the state of menisci of ink at the outlets becomes stable, to suppress the variation of the landing positions on the base material 9 and the like of ink with respect to the outlets, and it is thereby possible to realize printing of an image on the base material 9 with high precision.

In a comparative example of printer in which a lot of heads are arranged for each color, like in the ejection part 3 of FIG. 3, and an ink circulation mechanism is provided for every several heads, a lot of ink circulation mechanisms are needed, and the construction of the printer becomes complicated and the manufacturing cost for the printer increases. Further, in the comparative example of printer, since even a failure of one ink circulation mechanism inhibits printing, the availability (operation rate) of the printer decreases. Furthermore, since it is very difficult to equalize the flow rates of ink in the heads in a lot of ink circulation mechanisms, the landing positions and the like of ink with respect to the outlets in the plurality of heads vary.

In contrast to this, in the ink circulation mechanism 5 of FIG. 4, since the plurality of head units having the same construction are connected in parallel to the supply line 52 and the return line 53, the flow rates of ink are almost equalized in the heads 32 in all the head units 33 to print an image with high precision, and as compared with the comparative example of printer, it is possible to simplify the construction of the printer 1, increase the availability of the printer 1 and reduce the manufacturing cost of the printer 1.

Further, in the printer 1, since the area of the liquid surface in the second ink tank 51 is made larger than that of the liquid surface in the first ink tank 34, it is possible to efficiently perform degassing of ink in the second ink tank 51 with a great negative pressure (a pressure sufficiently lower than the atmosphere pressure) and to suppress dissolution of air into ink in the first ink tank 34.

In the printer 1 of FIG. 4, as discussed above, after the initial installation of ink, in starting to drive the printer 1 after a stop for a certain time period or more (for example, at start-up of the printer 1 every day), in maintenance in the case where a trouble in printing is caused or the like, the first ink tank(s) 34 gets connected to the compressed air source 376 with the first and second switching valves 372 and 373 and the inside of the first ink tank 34 is thereby pressurized to forcedly eject ink from the outlets in the plurality of heads 32. By such forced ejection of ink performed before the ink circulation, it becomes possible to remove unnecessary substances which could not be removed by ink circulation in the normal operation, such as the air bubbles existing in the vicinity of the outlets in the heads 32 and ink with increased viscosity retained in the heads 32, from the outlets.

Next, discussion will be made on a preferable connection of the supply line 52 in the first ink tank 34 and a preferable connection of the return line 53 in the second ink tank 51 in the printer 1.

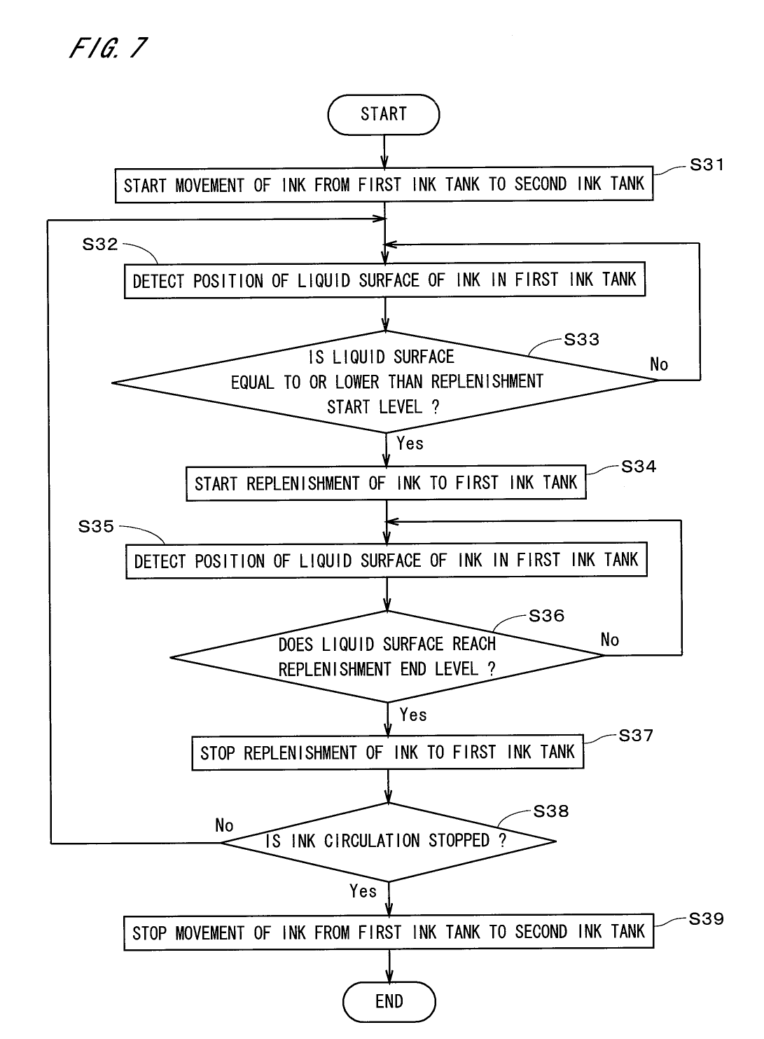

FIG. 8 is a view showing the vicinity of the first ink tank 34. As shown in FIG. 8, in the preferable first ink tank 34, an end portion of the supply line 52 on one side opposite to the second ink tank 51 is disposed in the vicinity of a bottom surface (lower surface) inside the first ink tank 34 so that ink flowing into the first ink tank 34 from the second ink tank 51 may remain at a position away from the liquid surface. Further, an end portion of the ink inlet pipe 351 (only one ink inlet pipe 351 is shown in FIG. 8) on one side opposite to the head 32 is connected to the bottom surface of the first ink tank 34. This makes it easier for the ink immediately after being flown from the inside of the second ink tank 51 to flow into the head 32 through the ink inlet pipe 351, as compared with the ink existing in the vicinity of the liquid surface of ink in the first ink tank 34. As a result, it is possible to suppress the inflow of the ink existing in the vicinity of the liquid surface in the first ink tank 34, which contains relatively much air, to the head 32. In FIG. 8, by changing the lengths of broken arrows with reference sign A1, it is indicated that the flow of ink is easy to cause in the vicinity of the bottom surface inside the first ink tank 34 and hard to cause in the vicinity of the liquid surface.

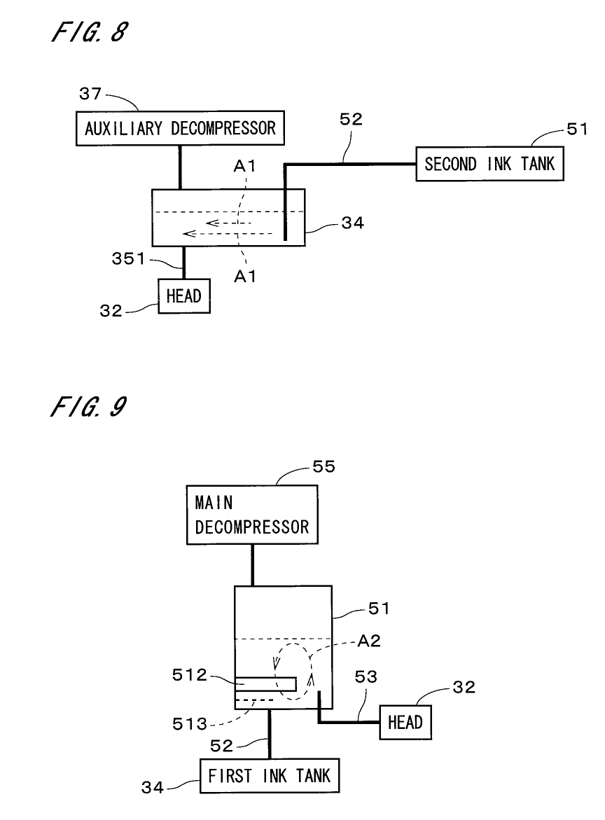

FIG. 9 is a view showing the vicinity of the second ink tank 51. As shown in FIG. 9, in the preferable second ink tank 51, an end portion of the return line 53 on one side opposite to the head 32 is open upward so as to face the liquid surface in ink inside the second ink tank 51 and this causes the ink flowing into the second ink tank 51 from the head 32 to go toward the liquid surface and to be agitated in the second ink tank 51. In FIG. 9, the flow of ink in the second ink tank 51 is indicated by a broken arrow with reference sign A2.

As discussed earlier, the second ink tank 51 is provided with the heater 512 and the temperature sensor 513, and with the agitation of ink, the temperature of ink in the second ink tank 51 is equalized. Further, with the agitation of ink, it is possible to efficiently perform degassing of ink with the great negative pressure (i.e., the pressure sufficiently lower than the atmosphere pressure) in the second ink tank 51, as compared with the case where ink remains in the vicinity of the liquid surface in the second ink tank 51. An end portion of the supply line 52 on one side opposite to the first ink tank 34 is connected to the bottom surface of the second ink tank 51.

As discussed above, the first ink tank 34 of FIG. 8 causes the ink containing relatively much air to remain in the vicinity of the liquid surface, to thereby suppress the dissolution of air into ink, and the second ink tank 51 of FIG. 9 promotes the degassing of ink with the agitation of ink. Therefore, in cooperation with the technique where the area of the liquid surface of ink in the second ink tank 51 is made larger than that of the liquid surface of ink in the first ink tank 34, it is possible to further suppress the dissolution of air into ink in the first ink tank 34 and to further promote the degassing of ink in the second ink tank 51.

In the above-discussed printer 1, though the negative pressure in the second ink tank 51 is made larger (i.e., the pressure in the second ink tank 51 is made lower) in the normal operation to thereby always perform active degassing of ink in the second ink tank 51, there may be a case where the negative pressure in the second ink tank 51 is made relatively small in the normal operation and the negative pressure in the second ink tank 51 is made larger regularly or nonregularly, to thereby perform active degassing.

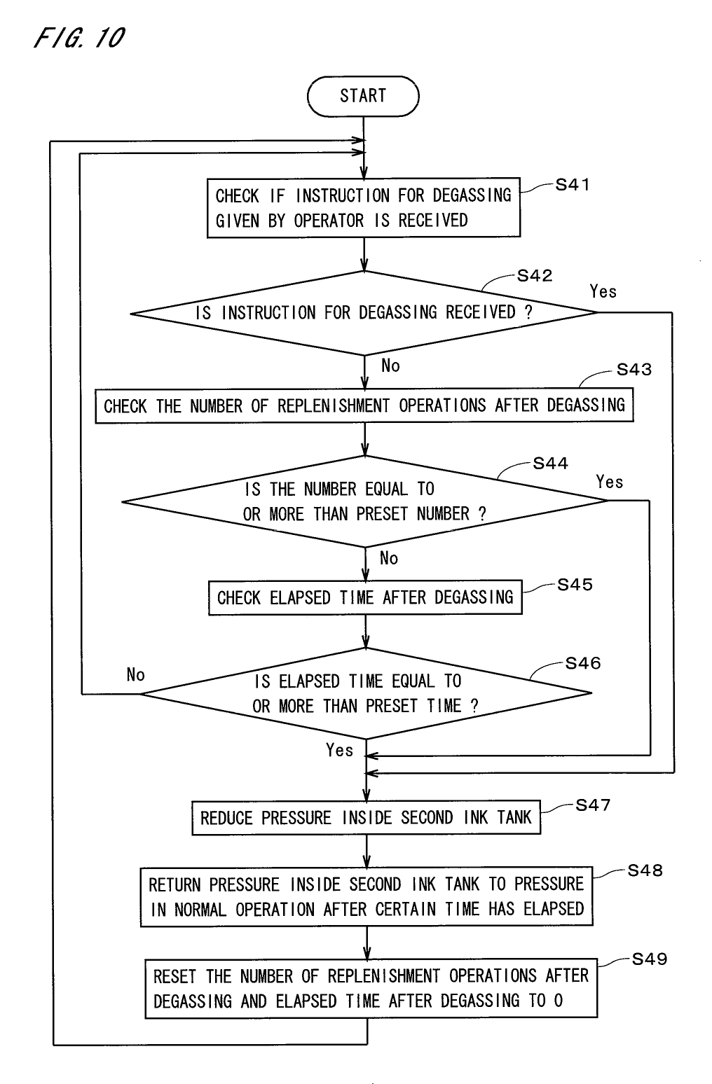

FIG. 10 is a flowchart showing an operation flow of degassing in the printer 1. In this exemplary normal operation, the pressure inside the second ink tank 51 of FIG. 4 is made higher than that in the above exemplary normal operation (e.g., a pressure lower than the atmosphere pressure by 100 mbar), to thereby return ink from the first ink tank 34 to the second ink tank 51 through the return passage, and the area of the passage opening in the flow regulating valve 531 (the area of a surface perpendicular to the passage) is made larger, to thereby ensure the same flow of ink as that in the above exemplary operation.

The control part 4 checks if an instruction of degassing given by an operator through an input part is received (Step S41) while performing the normal operation to circulate ink, and if the instruction is not received (Step S42), the number of operations performed to replenish ink from the main ink tank 56 to the second ink tank 51 after the immediately preceding degassing (hereinafter, referred to as “the number of replenishment operations after degassing”) is checked (Step S43). If the number of replenishment operations after degassing is less than a preset number which is set in advance (Step S44), the elapsed time from the immediately preceding degassing (hereinafter, referred to as “the elapsed time after degassing”) is checked (Step S45) and if the elapsed time after degassing is less than a predetermined preset time (Step S46), back to Step S41, it is checked whether the instruction by the operator is given or not.

Thus, the operations of Steps S41 to S46 are repeated concurrently with the normal operation, and if the instruction of degassing given by the operator is received (Step S42), if the number of replenishment operations after degassing is equal to or more than the preset number (Step S44) and if the elapsed time after degassing is equal to or more than the preset time (Step S46), the inside of the second ink tank 51 is decompressed to a pressure lower than the atmosphere pressure by e.g., 500 mbar (Step S47). At that time, by narrowing the passage opening in the flow regulating valve 531 (in other words, making the area of the passage opening smaller), the same flow rate as that in the normal operation can be ensured.

After a certain time has elapsed, the pressure inside the second ink tank 51 is returned to a pressure in the normal operation and the area of the passage opening in the flow regulating valve 531 is also returned to an area in the normal operation (Step S48). Then, the number of replenishment operations after degassing is reset to 0 and the elapsed time after degassing is also reset to 0 (Step S49). In the printer 1, the operations of Steps S41 to S49 are repeated concurrently with the normal operation and the degassing in the second ink tank 51 (i.e., the operation of Step S47) is performed regularly or nonregularly.

Thus, in the degassing operation, by using the main decompressor 55 to decompress the inside of the second ink tank 51 to a pressure lower than that in the normal operation and further narrowing the opening serving as a passage inside the flow regulating valve 531, it is possible to keep the flow rate of ink from the first ink tank 34 to the second ink tank 51 almost constant in the normal operation and the degassing operation while efficiently degassing ink in the second ink tank 51 in the degassing operation and the temperature of the heads 32 and that of ink in the heads 32 can be kept constant, to appropriately perform ejection of ink. Further, there may be a case where the flow of ink is kept constant by narrowing the area of the opening of the return line valve 533 in the degassing operation to be smaller than that in the normal operation, and in this case, it can be thought that the return line valve 533 serves as a flow limiting part.

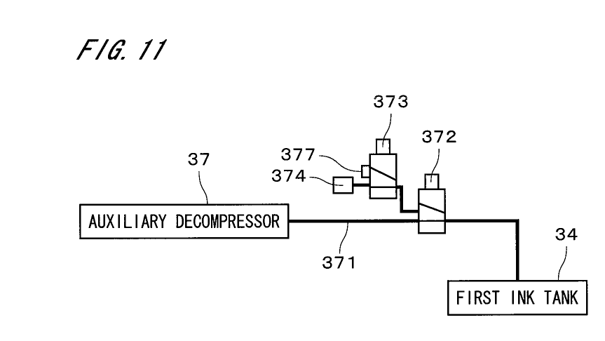

Further, in the printer 1 of FIG. 4, though the first ink tank 34 gets connected to the compressed air source 376 to forcedly eject ink from the outlets of the plurality of heads 32, such forced ejection of ink can be performed in a printer without the compressed air source 376. FIG. 11 is a view showing part of another exemplary printer, i.e., a mechanism relating to the change of the pressure in the first ink tank 34. In the printer of FIG. 11, a sealing member 377 is provided, instead of the compressed air source 376, in the passage which is connected to the compressed air source 376 in the printer 1 of FIG. 4. Constituent elements in the printer of FIG. 11 other than those shown in FIG. 11 are identical to those of the printer 1 of FIG. 4 and represented by the same reference signs.

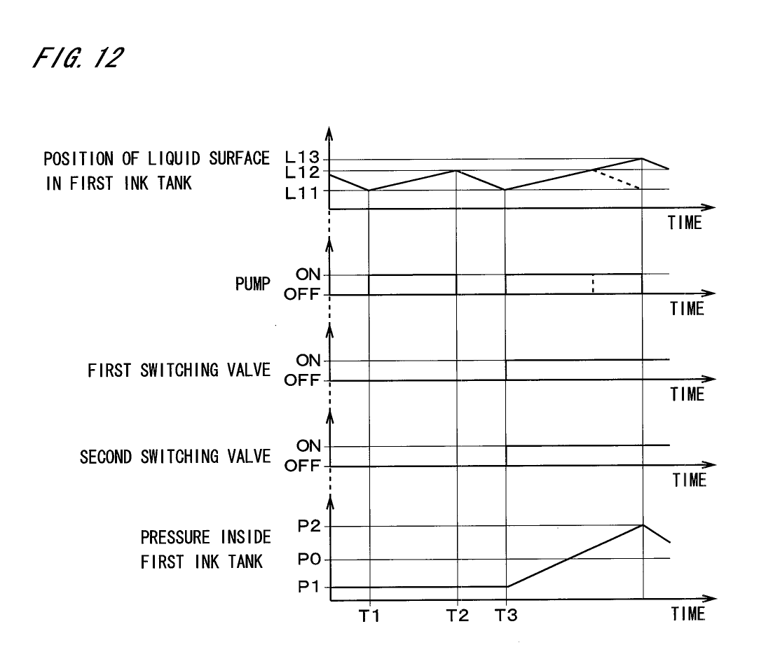

In the normal operation performed in the printer of FIG. 11, as indicated by the position at the time T1 in the top stage of FIG. 12, when the position of the liquid surface of ink in the first ink tank 34 becomes equal to or lower than a replenishment start level L11, the pump 54 is turned on and ink is supplied to the first ink tank 34 from the second ink tank 51 as indicated by the second stage from the top in FIG. 12. At that time, as indicated by the third and fourth stages from the top in FIG. 12, both the first and second switching valves 372 and 373 are turned off and as indicated by the bottom stage in FIG. 12, the inside of the first ink tank 34 is decompressed by the auxiliary decompressor 37 to a normal auxiliary-pressure P1.

Then, as indicated by the position at the time T2 in the top stage of FIG. 12, when the position of the liquid surface of ink in the first ink tank 34 reaches a replenishment end level L12, the pump 54 is turned off and the supply of ink to the first ink tank 34 from the second ink tank 51 is stopped as indicated by the third stage.

For forced ejection of ink from the outlets, at the time T3 when the position of the liquid surface of ink in the first ink tank 34 next becomes equal to or lower than the replenishment start level L11, the pump 54 is turned on and both the first and second switching valves 372 and 373 are turned on to seal the first ink tank 34 (except the supply line 52 and the plurality of ink inlet pipes 351) (see FIG. 4). Then, the driving of the pump 54 continues until the position of the liquid surface of ink in the first ink tank 34 reaches a predetermined level L13 higher than the replenishment end level L12. With this operation, the air inside the first ink tank 34 is compressed and the inside of the first ink tank 34 has a pressure P2 (purge pressure) higher than the atmosphere pressure P0, to thereby forcedly eject ink from the outlets in the plurality of heads 32. After that, in returning to the normal operation, both the first and second switching valves 372 and 373 are turned off to connect the first ink tank 34 to the auxiliary decompressor 37 and the on/off of the pump 54 is controlled in accordance with the position of the liquid surface of ink, whether the replenishment start level L11 or the replenishment end level L12.

Thus, in the printer of FIG. 11, in the forced ejection of ink from the outlets, the first and second switching valves 372 and 373 and the sealing member 377 serve as a sealing part to seal the first ink tank(s) 34 and ink is supplied into the first ink tank 34 by the pump 54 so that the amount of ink in the first ink tank 34 increases as compared with the normal operation. With this operation, it is possible to easily perform the forced ejection of ink from the plurality of outlets without the compressed air source 376 and the regulator 375 shown in FIG. 4 and to reduce the manufacturing cost for the printer.

Further, in the exemplary construction of FIG. 12, though the pump 54 is turned on from the time when the position of the liquid surface of ink in the first ink tank 34 becomes equal to or lower than the replenishment start level L11, to thereby supply ink into the first ink tank 34 up to the level L13 for the forced ejection of ink from the outlets, naturally, the pump 54 may be driven from the state where the ink level is higher than the replenishment start level L11, to forcedly eject ink.

Though the preferred embodiment of the present invention has been discussed above, the present invention is not limited to the above-discussed preferred embodiment, but allows various variations.

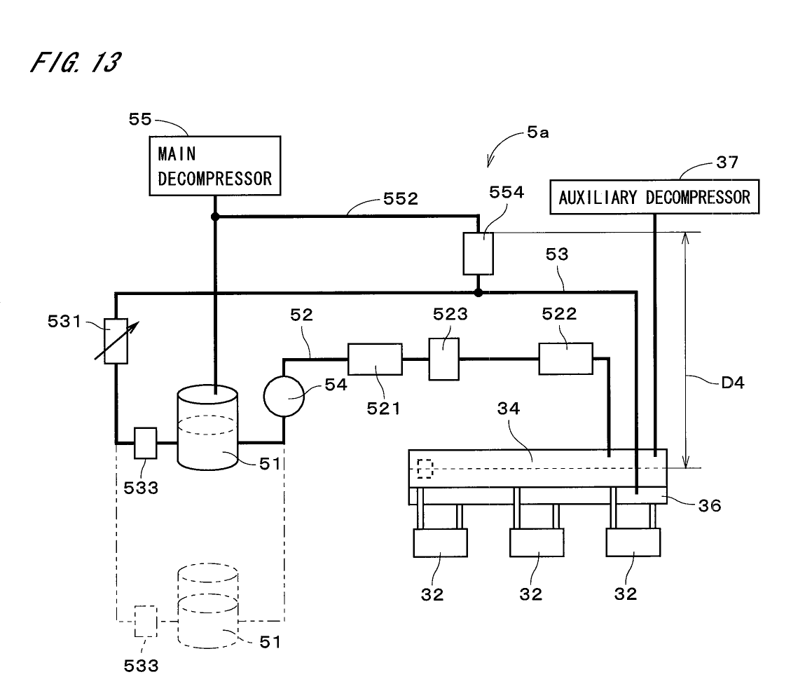

Though the second ink tank 51 is disposed at a position lower than the first ink tank 34 in the printer 1 of FIG. 4 (see the second ink tank 51 indicated by the two-dot chain line in FIG. 13), the second ink tank 51 may be disposed at a position higher than the first ink tank 34, like in an ink circulation mechanism 5a of FIG. 13. Also in the ink circulation mechanism 5a of FIG. 13, an uppermost part of the return line 53 is positioned upper than the liquid surface of ink in the first ink tank 34 and between the heads 32 and the return line valve 533 in the return line 53 and one end of the auxiliary passage 552 is connected to the uppermost part (or in the vicinity of the uppermost part).

In the ink circulation mechanism 5a of FIG. 13, in filling the return passage leading from the first ink tank 34 to the second ink tank 51 via the heads 32 with ink, like in the ink circulation mechanism 5 of FIG. 4, after the first ink tank 34 is filled with ink, with the return line valve 533 closed, the inside of the auxiliary passage 552 is decompressed so that the liquid surface of ink may be formed upper than the open/close position of the valve 554 in the auxiliary passage 552 (in other words, so that the liquid surface of ink may be formed at a position upper than the position of the liquid surface of ink in the first ink tank 34 by the height indicated by an arrow D4 of FIG. 13), to exclude the air in a part of the return passage which leads from the first ink tank 34 to the return line valve 533, and the part can be thereby filled with ink. Then, after closing the valve 554 of the auxiliary passage 552, the return line valve 533 is opened and the inside of the second ink tank 51 is decompressed to the normal circulation pressure, to thereby start the movement of ink from the first ink tank 34 to the second ink tank 51.

Thus, in the ink circulation mechanism 5a (or in the ink circulation mechanism 5), if it is thought that the main decompressor 55 for decompressing the inside of the auxiliary passage 552 while activated and the valve 554 for closing the auxiliary passage 552 while inactivated serve as a passage filling part, the passage filling part is activated with the return line valve 533 closed and ink is caused to flow into the auxiliary passage 552, to thereby fill a part of the return passage which leads from the first ink tank 34 to the return line valve 533 with ink, and after that, the passage filling part is inactivated to close the auxiliary passage 552 at the position where the ink exists, and the return line valve 533 is opened and the main decompressor 55 is driven, to thereby fill the whole of the return passage with ink. As a result, when the ink circulation is started, it is possible to prevent any gas from remaining in the return passage on the side of the first tank 34 viewed from the return line valve 533 and to prevent any trouble in ejection of ink due to the sucking of air from the outlets.

An ink circulation performed in the ink circulation mechanism 5a is the same as that performed in the ink circulation mechanism 5 of FIG. 4. Specifically, the pump 54 is driven to supply the first ink tank 34 with ink stored in the second ink tank 51, and the inside of the second ink tank 51 is decompressed to the negative pressure and ink is returned from the first ink tank 34 to the second ink tank 51. Thus, it is possible to appropriately circulate ink while degassing ink in the second ink tank 51 by using the negative pressure of the second ink tank 51.

In the ink circulation mechanisms 5 and 5a, in the initial installation of ink, though it is intended to simplify the construction of the printer by using the main decompressor 55 to decompress the inside of the auxiliary passage 552, another decompressor for decompressing the inside of the auxiliary passage 552 may be provided, depending on the design of the printer.

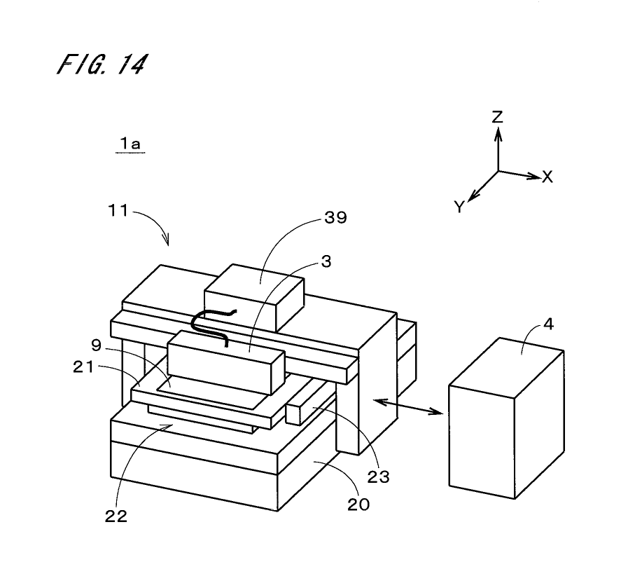

In the printer 1 of FIG. 2 (the so-called roll-to-roll printer), though the base material 9 is moved relatively to the ejection part 3 in the scan direction crossing the arrangement direction of the plurality of outlets at a constant speed by the feeder 27 for moving the base material 9 in the scan direction, a mechanism for moving the ejection part 3 in the scan direction may be provided in the printer 1. Further, like in a printer 1a (flat bed type printer) shown in FIG. 14, a stage 21 for holding the rectangular base material 9 and a stage moving mechanism 22 for moving the stage 21 in the scan direction (the Y direction in FIG. 14) may be provided. Thus, with various constructions, a scan mechanism for moving the base material 9 relatively to the ejection part 3 in the scan direction can be realized. In the printer 1a of FIG. 14, the position of the stage 21 relative to the base 20 can be detected by a position detecting module 23 provided on the base 20.

Photocurable ink used in the printer may be one having the curability to light in a wavelength range other than the ultraviolet rays. In such a case, the light emitted from the light emitting part 38 includes this wavelength range.

The printing medium used in the printer 1 may be a plate-like member which is formed of plastic, printing paper and the like, other than the sheet-like base material 9.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2008-137482 filed in the Japan Patent Office on May 27, 2008, the entire disclosure of which is incorporated herein by reference.

What is claimed is:

1. An inkjet printer, comprising:
a head for ejecting droplets of ink from a plurality of outlets arranged in an arrangement direction onto a printing medium which moves relatively to said plurality of outlets in a direction crossing said arrangement direction;
a first ink tank storing ink in the vicinity of said head, being connected to said head;
a second ink tank storing ink, being connected to said first ink tank through a supply line and connected to said head through a return line;
a pump provided in said supply line, for supplying said first ink tank with ink stored in said second ink tank; and
a decompressor for decompressing the inside of said second ink tank, to return ink from said first ink tank to said second ink tank through a passage which leads from said first ink tank to said second ink tank via said head, with said passage filled with ink.

2. The printer according to claim 1, wherein
an area of the liquid surface of ink stored in said second ink tank is larger than that of the liquid surface of ink stored in said first ink tank.

3. The printer according to claim 1, further comprising
another decompressor for decompressing the inside of said first ink tank,
wherein menisci of ink are formed in said plurality of outlets in a state where the inside of said first ink tank is decompressed by said another decompressor.

4. The printer according to claim 1, further comprising
another head which has the same structure as said head,
wherein said head and said another head are connected to said first ink tank in parallel and connected to said return line in parallel.

5. The printer according to claim 1, wherein
a pressure inside said second ink tank is kept almost constant by said decompressor.

6. The printer according to claim 1, further comprising:
a flow limiting part provided in said return line, for limiting flow of ink;
a valve provided between said flow limiting part and said second ink tank in said return line;
an auxiliary passage having one end connected to an uppermost part of said return line or in the vicinity of said uppermost part, said uppermost part being positioned upper than the liquid surface of ink stored in said first ink tank and positioned between said head and said valve in said return line; and
a passage filling part for decompressing the inside of said auxiliary passage while activated and closing said auxiliary passage while inactivated,
wherein said first ink tank is disposed above said head, and
in filling said passage which leads from said first ink tank to said second ink tank via said head with ink, ink is stored in said first ink tank, said passage filling part is activated with said valve closed, and the ink is caused to flow into said auxiliary passage without inflow of air from said plurality of outlets, to thereby fill a part of said passage which leads from said first ink tank to said valve, and then said passage filling part is inactivated to close said auxiliary passage at the position where the ink exists, said valve is opened and said decompressor is driven, to thereby cause the ink to fill the whole of said passage.

7. The printer according to claim 6, wherein
the other end of said auxiliary passage is connected to said decompressor, and
said passage filling part includes said decompressor.

8. The printer according to claim 5, further comprising
a flow limiting part provided in said return line, for limiting flow of ink,
wherein said decompressor causes a pressure inside said second ink tank in a degassing operation to become lower than that in a normal operation and said flow limiting part further narrows an opening serving as a passage thereinside.

9. The printer according to claim 1, further comprising
a sealing part for sealing said first ink tank,
wherein said sealing part seals said first ink tank and said pump is driven to supply said first ink tank with ink, whereby the amount of ink in said first ink tank becomes larger than that in a normal operation, in forcedly ejecting ink from said plurality of outlets.

10. The printer according to claim 1, wherein
said ink is photocurable.

11. An ink circulation method used in an inkjet printer, wherein
said printer comprises
a head for ejecting droplets of ink from a plurality of outlets arranged in an arrangement direction onto a printing medium which moves relatively to said plurality of outlets in a direction crossing said arrangement direction;
a first ink tank storing ink in the vicinity of said head, being connected to said head;
a second ink tank storing ink, being connected to said first ink tank through a supply line and connected to said head through a return line; and
a pump provided in said supply line,
said ink circulation method comprising the steps of:
a) supplying said first ink tank with ink stored in said second ink tank by driving said pump; and
b) returning ink from said first ink tank to said second ink tank through a passage which leads from said first ink tank to said second ink tank via said head, with said passage filled with ink, by decompressing the inside of said second ink tank.

12. The ink circulation method according to claim 11, wherein
an area of the liquid surface of ink stored in said second ink tank is larger than that of the liquid surface of ink stored in said first ink tank.

13. The ink circulation method according to claim 11, wherein
the inside of said first ink tank is decompressed to form menisci of ink in said plurality of outlets in said step b).

14. The ink circulation method according to claim 11, wherein
said printer further comprises another head which has the same structure as said head, and
said head and said another head are connected to said first ink tank in parallel and connected to said return line in parallel.

15. The ink circulation method according to claim 11, wherein
a pressure inside said second ink tank is kept almost constant in said step b).

16. The ink circulation method according to claim 15, wherein
said printer further comprises a flow limiting part which is provided in said return line and limits flow of ink, and
said ink circulation method further comprising the step of
performing a degassing operation by causing a pressure inside said second ink tank to become lower than that in a normal operation and further narrowing an opening serving as a passage inside said flow limiting part concurrently with said steps a) and b).

17. The ink circulation method according to claim 11, wherein
before said steps a) and b), said first ink tank is sealed and said pump is driven to supply said first ink tank with ink, whereby the amount of ink in said first ink tank becomes larger than that in a normal operation, as an operation of forcedly ejecting ink from said plurality of outlets.

18. The ink circulation method according to claim 11, wherein
said ink is photocurable.

19. An initial ink installation method used in an inkjet printer, wherein
said printer comprises
a head for ejecting droplets of ink from a plurality of outlets arranged in an arrangement direction onto a printing medium which moves relatively to said plurality of outlets in a direction crossing said arrangement direction;
a first ink tank storing ink above and in the vicinity of said head, being connected to said head;
a second ink tank storing ink, being connected to said first ink tank through a supply line and connected to said head through a return line;
a pump provided in said supply line, for supplying said first ink tank with ink stored in said second ink tank;
a decompressor for decompressing the inside of said second ink tank, to return ink from said first ink tank to said second ink tank through a passage which leads from said first ink tank to said second ink tank via said head, with said passage filled with ink;
a flow limiting part provided in said return line, for limiting flow of ink,
a valve provided between said flow limiting part and said second ink tank in said return line; and
an auxiliary passage having one end connected to an uppermost part of said return line or in the vicinity of said uppermost part, said uppermost part being positioned upper than the liquid surface of ink stored in said first ink tank and positioned between said head and said valve in said return line,
said initial ink installation method comprising the steps of:
a) filling a part of said passage which leads from said first ink tank to said valve with ink by storing the ink in said first ink tank and decompressing the inside of said auxiliary passage with said valve closed, to cause the ink to flow into said auxiliary passage without inflow of air from said plurality of outlets; and
b) filling the whole of said passage with the ink by closing said auxiliary passage at the position where the ink exists, opening said valve and driving said decompressor.

20. The initial ink installation method according to claim 19, wherein
the other end of said auxiliary passage is connected to said decompressor, and
said decompressor decompresses the inside of said auxiliary passage in said step a).
